(19) United States
(12) Patent Application Publication
(10) Pub. No.: US 2017/0099366 A1
(43) Pub. Date: Apr. 6, 2017

(54) INTELLIGENT ROUTING BETWEEN WEARABLE GROUP COMMUNICATION DEVICES

(71) Applicant: Orion Labs, San Francisco, CA (US)

(72) Inventors: Greg Albrecht, San Francisco, CA (US); Jesse Robbins, San Francisco, CA (US); Andy Isaacson, San Francisco, CA (US); Nelson Carpentier, San Francisco, CA (US); Star Simpson, San Francisco, CA (US)

(21) Appl. No.: 15/281,588

(22) Filed: Sep. 30, 2016

Related U.S. Application Data
(60) Provisional application No. 62/235,983, filed on Oct. 1, 2015.

(51) Int. Cl. H04L 29/08; H04L 29/06

(52) U.S. Cl. CPC H04L 67/2842; H04L 67/1046; H04L 63/04; H04L 67/1059

(57) ABSTRACT

Data transfers between communication node members of a communication node group are routed to and from a data cache network that includes a cache node. Data sent by one node to another node is first sent to the cache network. A cache network deposit channel is opened between the first node and the cache network. The first node sends the data to the cache network, which stores the data in the cache node. To retrieve the data, the second node uses a retrieval channel opened between the cache network and the second node. The data is then transmitted from the cache network to the second node. Multiple deposit channels and retrieval channels can be opened and utilized as needed.

### RELATED APPLICATIONS

This application hereby claims the benefit of and priority to U.S. Provisional Patent Application 62/235,983, entitled “INTELLIGENT ROUTING BETWEEN WEARABLE GROUP COMMUNICATION DEVICES,” filed 1 Oct. 2015, and which is hereby incorporated by reference in its entirety.

### TECHNICAL FIELD

Aspects of the disclosure are related to the field of communications and, in particular, to data caching for group communications.

### TECHNICAL BACKGROUND

Various communication devices can be employed to facilitate communication between users. These devices can include cellular telephones, smartphones, discrete devices, computers, and tablets, among others, which provide an efficient way for users to communicate without being in the same physical location. These devices may be grouped together to facilitate communications among some, but not all, devices on a network. Thus one or more groups having member devices can be defined and can operate on the network. Data such as audio streams may then be transferred among these devices (including limiting data transfers only to and/or within a selected group of devices) as needed. However, depending on transmission conditions and capabilities, and bandwidth limitations, some devices may be slower than others to transmit or receive large amounts of data.

### OVERVIEW

Data transfers between communication node members of a communication node group can be routed to and from a data cache network that includes one or more cache nodes. Data intended to be sent by a first node to a second node is sent to the cache network as an intermediate step. A cache network deposit channel is opened between the first node and the cache network (e.g., by a remote management system that manages the communication group). The first node sends the data to the cache network, which stores the data (e.g., in a cache node). When the second communication node wishes to retrieve the data from the first node, a retrieval channel is opened between the cache network and the second node. The data is then transmitted from the cache network to the second node.

Multiple deposit channels and retrieval channels can be opened and utilized as needed. Moreover, transmission between nodes and the cache network can be secured (e.g., when the transmitting and retrieving nodes are not members of the same communication group). Each communication node can include a discrete device paired with a personal communication device such as a smartphone, tablet computer, etc. in some implementations. Alternatively, a communication node can be a personal communication device implementing software to perform as described.

### BRIEF DESCRIPTION OF THE DRAWINGS

FIG. 1 illustrates a communication system.

FIG. 2 illustrates a communication system.

FIG. 3 illustrates a communication system.

FIG. 4 illustrates a remote management system.

FIG. 5 illustrates a method for operating a remote management system and/or cache network.

FIG. 6 illustrates two or more non-limiting examples of a communication node.

### DETAILED DESCRIPTION

In the examples below, personal communication nodes are discussed which allow group communication sessions among various users. These personal communication nodes can include discrete devices (e.g., wearable devices) specialized for group communications that include one or more wireless transceivers and user interface elements tailored to streamlined group communications. In some implementations each discrete device is paired with an intermediate communication device such as a personal communication device. The group communications can be initiated and altered either by user action or intervention or automatically by a shared remote management system which can respond (e.g. in response to one or more dynamic factors) to form or change groups or group status. In some examples, the features of the discrete devices can be incorporated into other devices, such as personal communication devices (non-limiting examples of which comprise cellular smartphones, gaming devices, personal computers, tablet computers, and the like). Voice command features can be included that comprise group forming and alteration features, keyword-based searching, productivity assistance, or navigation assistance, among other features. Further features can include conversational interaction for information transmittal or retrieval, such as activity reminders, weather, stocks, messaging, email, calendar, contacts, notes, music, clocks, web browsers, maps and other applications.

Once these groups have been formed, communication nodes that are members within a group may exchange secure group member communications with each other while maintaining communication with a remote management system that configures and controls the groups using management communications. However, if one or more communication nodes need to exchange large amounts of data with each other (e.g., a large file), a cache network is provided in some implementations to store the data temporarily. For example, if one communication node needs to send a large audio file to several other communication nodes, it may be more efficient to deposit (i.e., put) the audio file into a storage system within the cache network for each of the other communication nodes to retrieve (i.e., get) at their convenience. Conversely, if several communication nodes each need to send an audio file to a single communication node, they may deposit their audio files into a storage system within the cache network for the single communication node to retrieve at its convenience. Operation of the cache network may be similar to a content delivery node in some implementations.

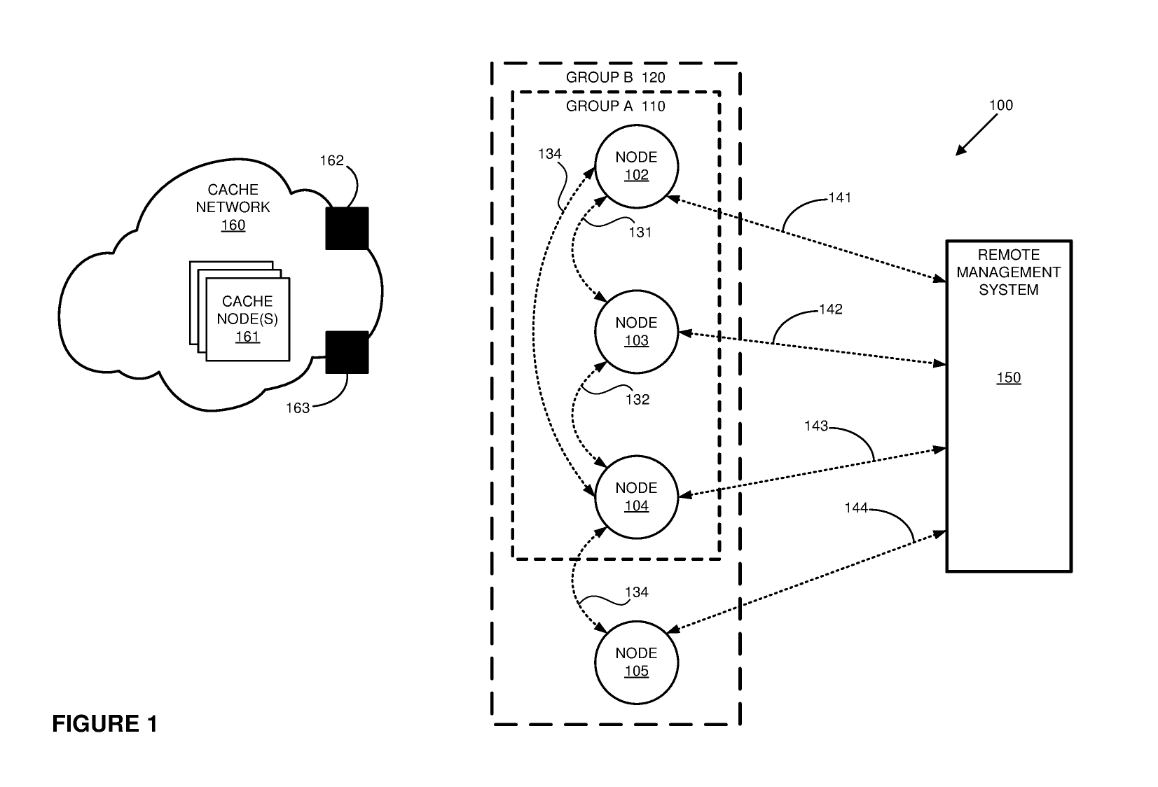

In a first example, FIG. 1 illustrates communication system 100, which can be employed to provide intelligent agent features for communication nodes 102-105. System 100 includes communication nodes 102-105, and remote management system 150. Communication nodes 102-105 typically operate in groups, such as Group A 110 and Group B 120 for example. These groups can be defined by remote management system 150 (e.g., based on dynamic attributes communicated to remote management system 150 from communication nodes 102-105 or monitored by remote management system 150, or based on node user inputs). Group A 110 and Group B 120 can each comprise a nexus of specified communication nodes 102-105 for interactive communications, information sharing, data exchange, and other mutual exchange.

This example also includes cache network 160 which can include cache node 161. Cache network 160 and cache node 161 may be local or distributed systems capable of depositing (storing) data in cache node 161 for later retrieval. Cache network 160 includes deposit channel 162 (also referred to as a “put channel”), a port through which an authorized communication node may push data into cache node 161. Cache network 160 also includes retrieval channel 163 (also referred to as a “get channel”), a port through which an authorized communication node may pull data from cache node 161. Deposit channel 162 and retrieval channel 163 may be created and configured in response to instructions from one or more of communication nodes 102-105 or from remote management system 150.

Communication nodes 102-105 may each comprise transceivers, audio transducers, processing systems, communication interfaces, environmental sensors, accelerometers, gyroscopes, Global Positioning System (GPS) receivers, user interfaces, and other systems. Remote management system 150 may comprise a computing system comprising one or more computing devices capable of managing services to a plurality of communication nodes, such as communication nodes 102-105.

Communication nodes 102-105 communicate with each other or with other communication nodes or intelligent agents over associated links 131-134. Communication links 131-134 can be used to connect communication nodes 102-105 to each other and/or to other personal communication nodes. In some examples, links 131-134 may comprise a mesh network among communication nodes 102-105. Communication nodes 102-105 can also communicate with remote management system 150 over associated ones of management links 141-144, which can comprise one or more network links in this example. Management links 141-144 connect communication nodes 102-105 to remote management system 150.

Links 131-134 and 141-144 can each comprise one or more wireless links that can each further include Long Term Evolution (LTE), Global System For Mobile Communications (GSM), Code Division Multiple Access (CDMA), IEEE 802.11 WiFi, Bluetooth, Personal Area Networks (PANs), Wide Area Networks, (WANs), Local Area Networks (LANs), or Wireless Local Area Networks (WLANs), including combinations, variations, and improvements thereof. These links can carry any communication protocol suitable for wireless communications, such as Internet Protocol (IP) or Ethernet.

Furthermore, links 131-134 can comprise Bluetooth, IEEE 802.11 WiFi, infrared, ultrasonic, or any wireless communication format including combinations, variations or improvements thereof. Communication links 131-134 can each use air or space as the transport media. Additionally, links 141-144 can include one or more wired portions which can comprise synchronous optical networking (SONET), hybrid fiber-coax (HFC), Time Division Multiplex (TDM), asynchronous transfer mode (ATM), circuit-switched, communication signaling, or some other communication signaling, including combinations, variations or improvements thereof. Communication links 141-144 can each use metal, glass, optical, air, space, or some other material as the transport media. Communication links 131-134 and 141-144 may each be a direct link, or may include intermediate networks, systems, or devices, and may include a logical network link transported over multiple physical links.

In FIG. 1, each communication node 102-105 monitors one or more attributes from associated positional sensors, audio transducers, GPS receivers, accelerometers, wireless transceivers, environmental sensors, or other sensors or devices capable of monitoring the attributes discussed herein. These attributes can comprise data or information that may be used for dynamically forming and changing node groups as well as for intelligent agent features for communication nodes 102-105. For example, one or more of the sound level of an environment, user preferences, proximity of one personal communication node to another, location, communication status, identity, and traveling speed may be attributes used for dynamically forming and changing groups of nodes as well as for intelligent agent features for communication nodes 102-105.

Communication nodes 102-105 periodically transfer messages for delivery to remote management system 150 (e.g., indicating dynamic changes in one or more attributes, user inputs, and/or other data useful in managing a node or a group). Communication nodes 102-105 may transfer a message to remote management system 150 whenever an attribute changes and/or at periodic intervals. Remote management system 150 can use dynamic changes in one or more attributes to form, modify and/or terminate groups of communication nodes 102-105 and for intelligent agent features for communication nodes 102-105. Although remote management system 150 and nodes 102-105 are each shown as separate entities in FIG. 1, it should be understood that features of remote management system 150 can be included in any of personal communication nodes 102-105.

Communication nodes may use secure communication methods for communicating with members of the communication groups, with non-members and/or with a remote management system or the like. Secure communication methods include systems, techniques, protocols, methods and other approaches enabling users and nodes to securely share communications and other information with one another without interception or monitoring of the information or associated communications by non-members and/or third-party. Secure communication methods may comprise symmetric key encryption, asymmetric key encryption, public-key encryption, or some other type of encryption, including combinations thereof. The actual communications between personal communication nodes can employ secure communication methods, and the associated links can employ secure communication methods independently.

End to end encryption of communications, such as audio communications, can be established among members of the group. These end-to-end encrypted communications can include transport layer security (TLS) or secure sockets layer (SSL) communications, among other secure link types. For example, a secure communication session can be established among nodes 102-105 in Group B 120 of FIG. 1, as well as among nodes 102-104 in Group A 110.

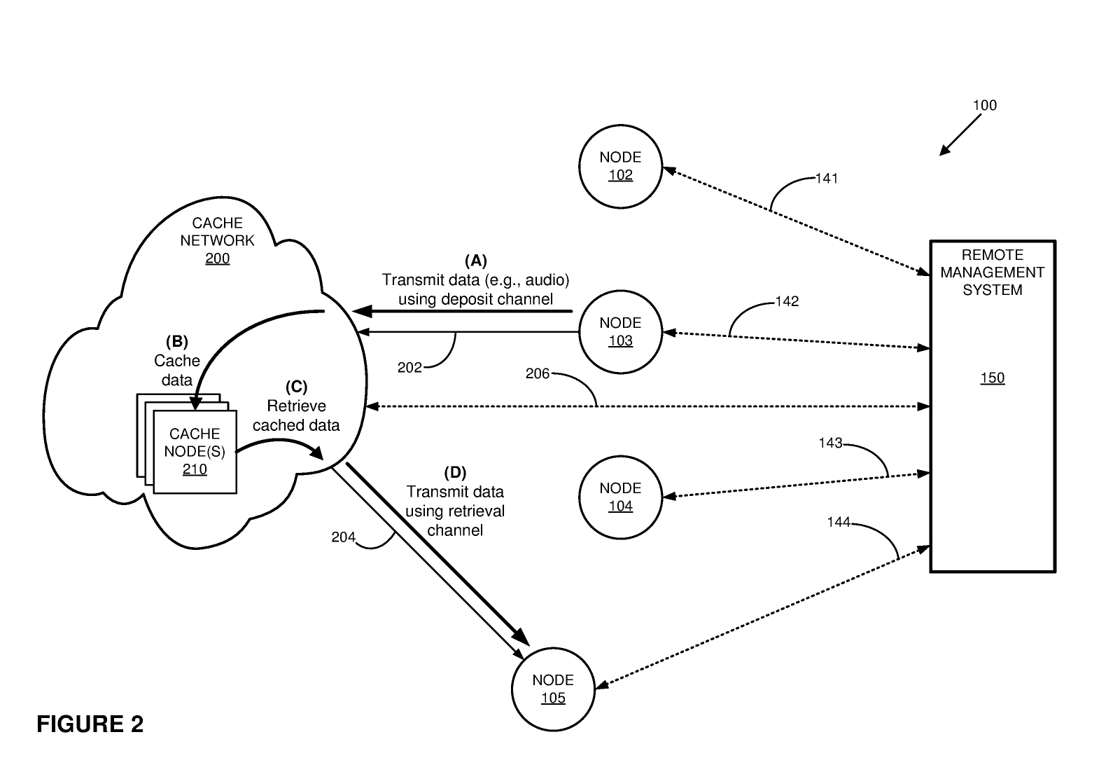

FIG. 2 illustrates communication system 100 of FIG. 1 which comprises cache network 200. Cache network 200 includes one or more cache nodes such as cache node 210, which may include a local or a distributed storage system. Remote management system 150 may provide instructions and configuration information to cache network 200 through control channel 206. In some implementations the cache network 200 and/or any cache nodes can be part of remote management system 150.

In this non-limiting example, communication node 103 needs to send data (e.g., audio data) to node 105. A deposit channel 202 is opened between node 103 and cache network 200 (e.g., based on instructions from remote management system 150, node 103, or cache network 200). Node 103 sends the data through deposit channel 202 to cache network 200 for storage (step (A)). The data from node 103 is stored in cache node 210 (step (B)). A retrieval channel 204 is opened between node 105 and cache network 200 (e.g., based on instructions from remote management system 150, node 105, or cache network 200). Cache network 200 can then transfer the stored data (step (C)) from cache node 210 to node 105 through retrieval channel 204 (step (D)). Retrieval of cached data may be performed in various ways (e.g., per instructions from node 103, node 105, cache node 210, cache network 200 and/or remote management system 150, or at the request of node 105 at a desired time). The decision as to whether or not to utilize cache network 200 can be determined in advance by remote management system 150 (e.g., implementing settings or the like in each node or when a group is formed or updated), by either the transmitting or receiving node (e.g., using filters, user settings, software instructions, etc.), or by cache network 200 (e.g., by monitoring communications among nodes).

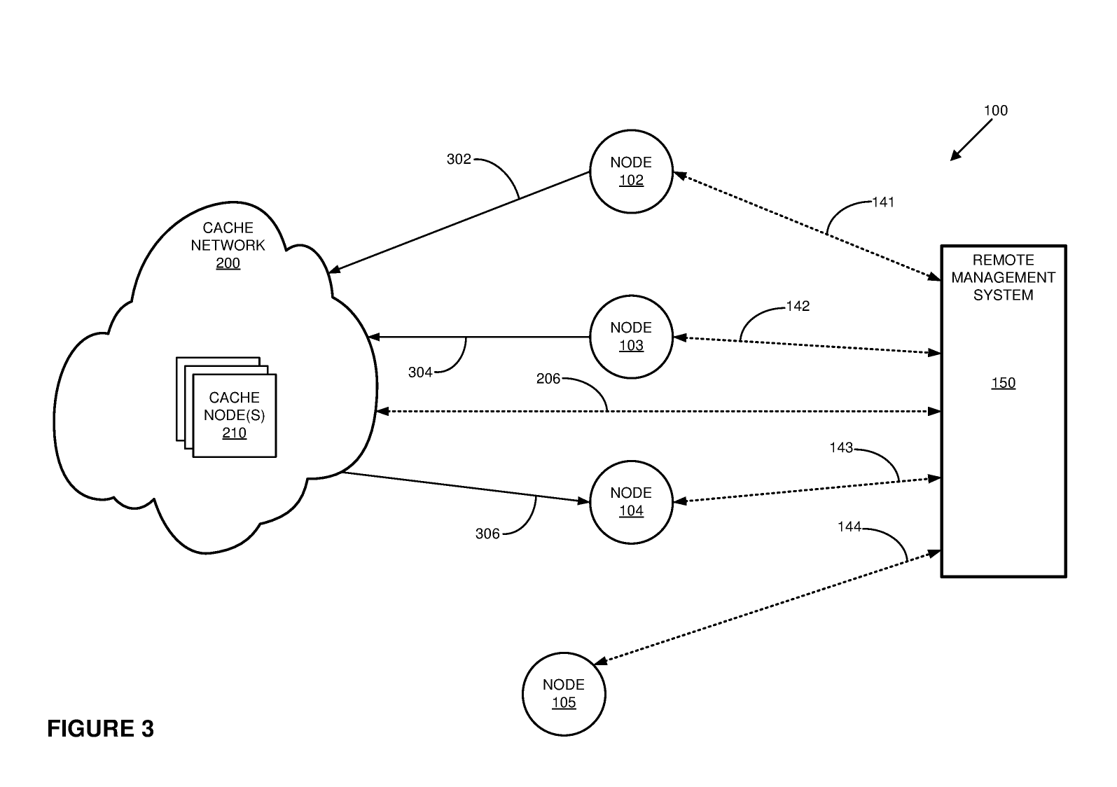

FIG. 3 illustrates communication system 100 of FIG. 1, with the addition of cache network 200 as shown in FIG. 2. In this non-limiting example, communication nodes 102 and 103 both need to send data to node 104. Deposit channel 302 is opened between node 102 and cache network 200. Similarly, deposit channel 304 is opened between node 103 and cache network 200. Node 102 sends its data to cache network 200 through deposit channel 302 for storage in cache node 210. Node 102 sends its data to cache network 200 through deposit channel 304 for storage in cache node 210.

Retrieval channel 306 is opened between cache network 200 and node 104. Cache network 200 transmits the data deposited by node 102 and node 103 through retrieval channel 306 to node 104.

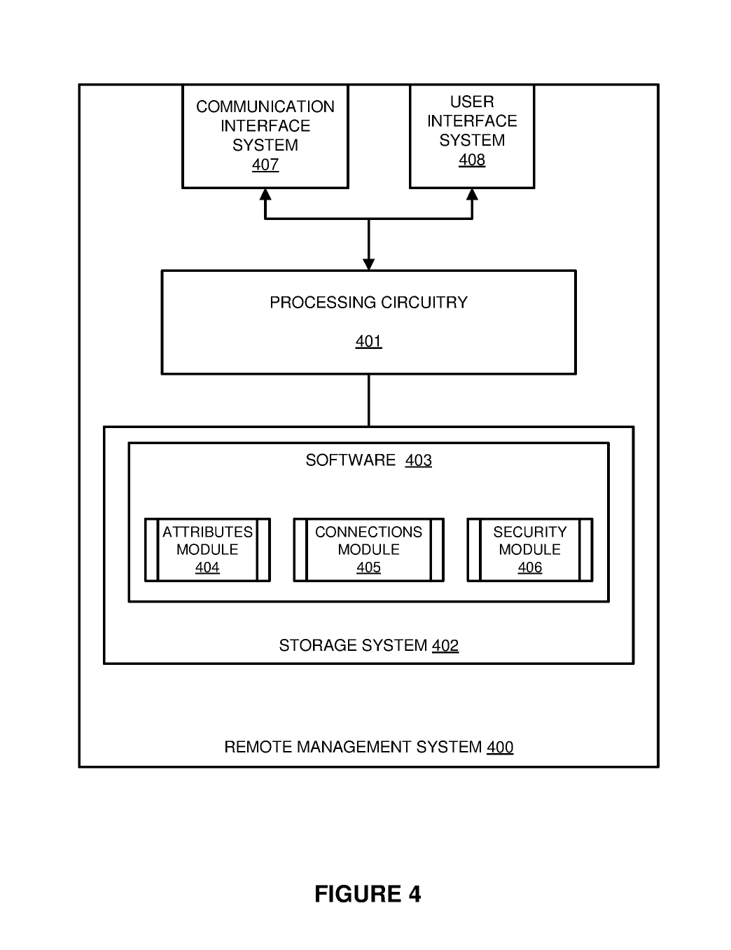

FIG. 4 illustrates one or more implementations of a remote management system 400. System 400 is a non-limiting example (e.g., of a computing environment that can execute features of remote management system 150 of FIG. 1 and/or remote management systems discussed herein). Furthermore, elements of remote management system 400 can be distributed over one or more computing devices (including one or more communication nodes). Remote management system 400 includes processing circuitry 401, storage system 402, software 403, communication interface system 407, and user interface system 408.

It may be understood that remote management system 400 is generally intended to represent one or more computing systems on which software 403 may be deployed and executed (e.g., in order to implement remote management system 150). However, remote management system 400 may also be suitable as any computing system on which software 403 may be staged and from where one or both may be distributed, transported, downloaded, or otherwise provided to yet another computing system for deployment and execution, or yet additional distribution.

Communication interface system 407 may include communication connections and devices that allow for communication with other computing systems over a communication network. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media.

User interface system 408 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 408. In some cases, the input and output devices may be combined in a single device, such as a display capable of displaying images and receiving touch gestures.

User interface system 408 may also include associated user interface software executable by processing circuitry 401 in support of the various user input and output devices discussed above. Separately or in conjunction with each other and other hardware and software elements, the user interface software and user interface devices may support a graphical user interface, a natural user interface, or any other type of user interface. In addition, user input made with respect to the user interfaces may be input via user interface system 408.

Communication between remote management system 400 and any other computing system may occur over a communication network or networks and in accordance with various communication protocols, combinations of protocols, or variations thereof. Examples of such communication networks include intranets, internets, the Internet, local area networks, wide area networks, wireless networks, wired networks, virtual networks, software defined networks, data center buses, computing backplanes, or any other type of network, combination of network, or variation thereof. Some communication protocols that may be used include, but are not limited to, the Internet protocol (IP, IPv4, IPv6), the transfer control protocol (TCP), and the user datagram protocol (UDP), as well as any other suitable communication protocol, variation, or combination thereof.

Processing circuitry 401 can comprise one or more microprocessors and other processing circuitry that retrieves and executes software 403 from storage system 402. Processing circuitry 401 can be implemented within a single processing device but can also be distributed across multiple processing devices or sub-systems that cooperate in executing program instructions. Examples of processing circuitry 401 include general purpose central processing units, application specific processors, and logic devices, as well as any other type of processing device, combinations, or variations thereof. In some examples, portions of processing circuitry 401 is physically separate from some elements of remote management system 400 and area included in remote servers, cloud-based processing systems, or virtualized computing systems.

Storage system 402 can comprise any non-transitory computer readable storage media capable of storing software 403 that is executable by processing circuitry 401. Storage system 402 can also include various data structures which comprise one or more databases, tables, lists, or other data structures. Storage system 402 can include volatile and nonvolatile, removable and non-removable media implemented in any method or technology for storage of information, such as computer readable instructions, data structures, program modules, or other data. Storage system 402 can be implemented as a single storage device but can also be implemented across multiple storage devices or sub-systems co-located or distributed relative to each other. Storage system 402 can comprise additional elements, such as a controller, capable of communicating with processing circuitry 401. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Software 403 can be implemented in program instructions and among other functions can, when executed by remote management system 400 in general or processing circuitry 401 in particular, direct remote management system 400, or processing circuitry 401 to operate as described herein for a remote management system or other functional systems. Software 403 can include additional processes, programs, or components, such as operating system software, database software, or application software. Software 403 can also comprise firmware or some other form of machine-readable processing instructions executable by elements of processing circuitry 401.

In at least one implementation, the program instructions can include attributes module 404 and connection module 405. The program instructions may also include a security module in some implementations. Attributes module 404 can monitor one or more attributes of personal communication nodes (e.g., transferring messages for delivery to a management system indicating dynamic changes in one or more attributes). These attributes and dynamic changes in attributes can be used to form and change dynamic communication groups among personal communication nodes and intelligent agent nodes. Attributes module 404 may periodically or continuously monitor attributes associated with personal communication node sensors or personal communication nodes may send messaging or alerts to attributes module 404 when changes are detected. Attributes module 404 receives attributes (e.g., from communication nodes 102-105) and transmits attributes (e.g., to remote management system 150 and/or communication nodes 102-105 over management communication links 141-144).

Connection module 405 can monitor communications among the various communication nodes 102-105, open deposit and retrieval channels in connection with cache network 200 as needed by communication nodes 102-105, and control communications and/or other connections between communication nodes 102-105 and with cache network 200. Security module 406 can initiate, control, and maintain secure communications between a remote management system and associated communication nodes, as well as secure communications between the nodes and a cache network and/or any cache nodes. For example, when data is being deposited with or retrieved from cache network 200 of FIGS. 2 and 3, security module 406 can establish secure communication links through deposit and/or retrieval channels.

In general, software 403 can, when loaded into processing circuitry 401 and executed, transform processing circuitry 401 overall from a general-purpose computing system into a special-purpose computing system customized to operate as described herein for a remote management system, among other operations. Encoding software 403 on storage system 402 can transform the physical structure of storage system 402. The specific transformation of the physical structure can depend on various factors in different implementations of this description. Examples of such factors can include, but are not limited to the technology used to implement the storage media of storage system 402 and whether the computer-storage media are characterized as primary or secondary storage. For example, if the computer-storage media are implemented as semiconductor-based memory, software 403 can transform the physical state of the semiconductor memory when the program is encoded therein. For example, software 403 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

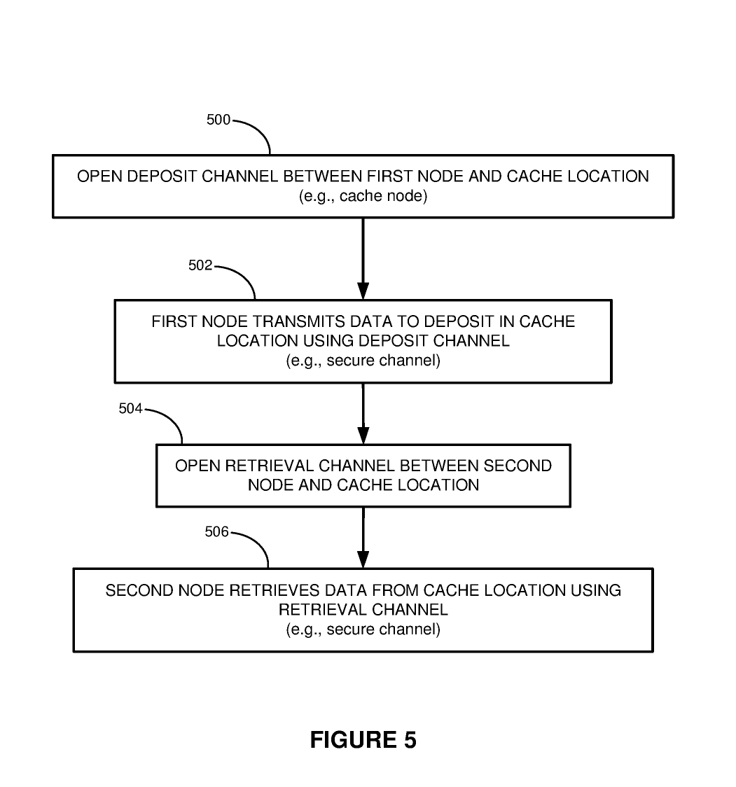

FIG. 5 illustrates a method for operating a remote management system (e.g., remote management system 150 as illustrated in the Figures). Instructions (e.g., from the remote management system or a first communication node) cause a cache network to open a deposit channel (operation 500) to a cache node (e.g., within the cache network). The first communication node sends data to the cache node through the deposit channel (operation 502).

Instructions (e.g., from the remote management system or a second communication node) cause the cache network to open a retrieval channel with access to the cache node in which the deposited data is stored (operation 504). The cache network transmits the data from cache node 210 to the second communication node through the retrieval channel (operation 506). In some implementations the cache node may be included in the remote management system.

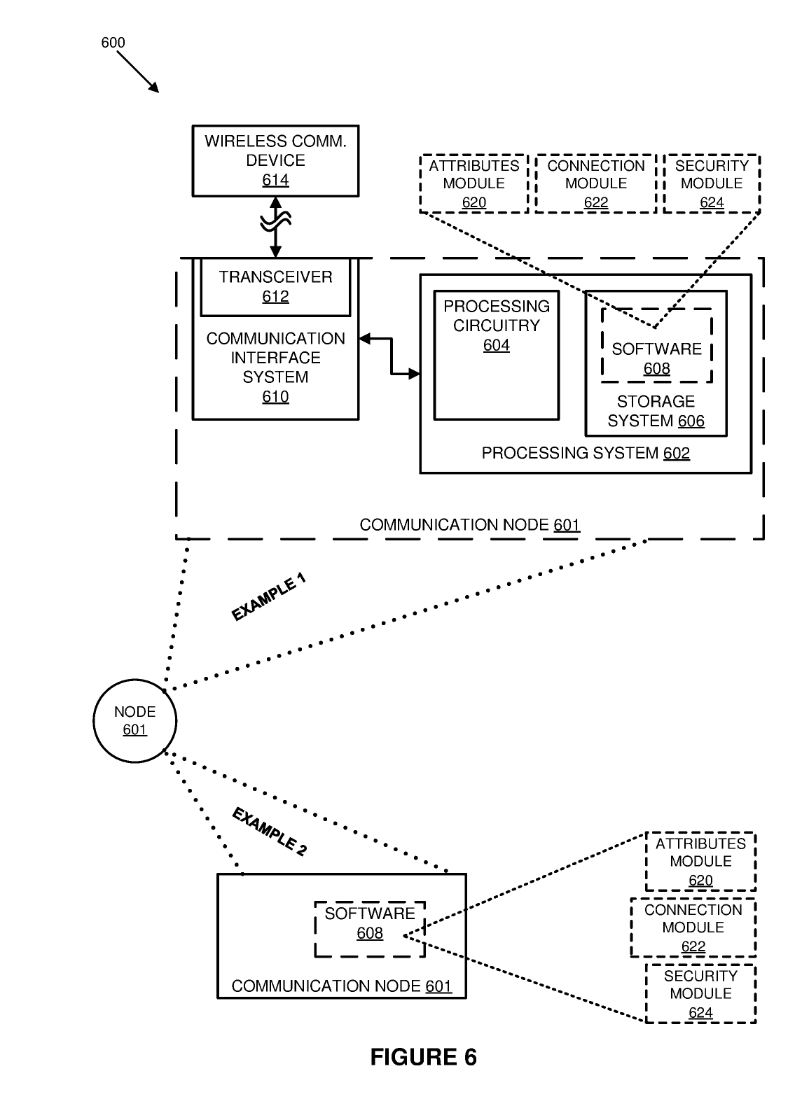

FIG. 6 illustrates two or more exemplary systems 600 for personal communication nodes, such as personal communication node 601. Personal communication node 601 is an example of or can be part of personal communication nodes 102-105; however, personal communication node 601 may have alternative configurations and methods of operation. Example 1 comprises node 601 and wireless communication device 614. Wireless communication device 614 may comprise a smartphone, tablet device, computer, gaming device, laptop computer, or some other communication device capable of communicating using packet networks or some other communication network. Example 2 illustrates personal communication node software within an operating environment of an electronic device, wherein the electronic device may comprise a smartphone, tablet device, computer, gaming device, laptop computer, or some other communication device capable of communicating using packet networks or some other communication network, running a personal communication node software application that comprises personal communication node 601.

In the non-limiting example of Example 1, node 601 further comprises processing system 602 and communication interface system 610. Processing system 602 further comprises processing circuitry 604 and storage system 606. Processing circuitry 604 comprises microprocessors and other circuitry that retrieves and executes software 608 from storage system 606. Processing circuitry 604 may comprise a single device or could be distributed across multiple devices—including devices in different geographic areas. Processing circuitry 604 may be embedded in various types of equipment.

Storage system 606 comprises a non-transitory computer readable storage medium, such as a disk drive, flash drive, data storage circuitry, or some other hardware memory apparatus. Storage system 606 may comprise a single device or could be distributed across multiple devices—including devices in different geographic areas. Storage system 606 may be embedded in various types of equipment. In some examples, a computer apparatus could comprise processing circuitry 604, storage system 606 and software 608. Software 608 comprises attributes module 620 and connection module 622. In some implementations a security module 624 might also be included. In addition, software 608 may include operating systems, utilities, drivers, network interfaces, applications, or some other type of software.

Attributes module 620 monitors one or more attributes of personal communication node 601 (e.g., periodically transferring a message for delivery to a management system indicating dynamic changes in one or more attributes). Personal communication node 601 may comprise attribute sensors such as transceivers, speakers, microphones, processing systems, communication interfaces, environmental sensors, accelerometers, gyroscopes, Global Positioning System (GPS) receivers, user interfaces and other systems to monitor various attributes and provide communications to remote management system 150. Attributes module 620 may periodically or continuously monitor attribute sensors or attribute sensors may send an interrupt to attributes module 620 when a change is detected.

Connection module 622 can instruct cache network 200 to open deposit channels and retrieval channels as needed. It can further control sending data to cache node 210 in cache network 200 through a deposit channel, and receiving data from cache node 210 in cache network 200 through a retrieval channel Security module 624 can assist in securing data transfers and communications as desired (e.g., through encryption and the like).

Communication interface system 610 further comprises transceiver 612 for communicating with wireless communication device 614. Transceiver 612 comprises communication components, such as ports, signal processing circuitry, memory, software, and the like. Transceiver 612 communicates with wireless communication device 614 over a link that may comprise a Bluetooth communication link, WiFi link, infrared, ultrasonic or any other communication link between personal communication node 601 and wireless communication device 614.

In the non-limiting example of Example 2, node 601 may comprise a processing system further comprising processing circuitry and a storage system. Processing circuitry may comprise microprocessors and other circuitry that retrieves and executes software 608. Processing circuitry may comprise a single device or could be distributed across multiple devices—including devices in different geographic areas. Processing circuitry may be embedded in various types of equipment. Node 601 may also comprise a storage system further comprising a non-transitory computer readable storage medium, such as a disk drive, flash drive, data storage circuitry, or some other hardware memory apparatus. The storage system may comprise a single device or could be distributed across multiple devices—including devices in different geographic areas. The storage system may be embedded in various types of equipment.

Node 601 further comprises software 608 including attributes module 620 and connection module 622 (and an optional security module 624 in some implementations). In addition, software 608 may include operating systems, utilities, drivers, network interfaces, applications, or some other type of software. Attributes module 620 monitors one or more attributes of personal communication node 601 (e.g., periodically transferring a message for delivery to a management system indicating dynamic changes in one or more attributes).

Connection module 622 instructs cache network 200 to open deposit channels and retrieval channels as needed. It further controls sending data to cache node 210 in cache network 200 through a deposit channel, and receiving data from cache node 210 in cache network 200 through a retrieval channel Security module 624 can assist in securing data transfers and communications as desired (e.g., through encryption and the like).

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A method of operating a remote management system, the method comprising:
opening a first deposit channel from a first communication node to a storage system in a cache network, wherein the first deposit channel is configured to permit transfer of first node data from the first communication node to the storage system; and
opening a first retrieval channel from the storage system to a second communication node, wherein the first retrieval channel is configured to permit transfer of the first node data from the storage system to the second communication node.

2. The method of claim 1 wherein the storage system comprises a cache node configured to hold the first node data sent by the first communication node until the first node data is retrieved by the second communication node.

3. The method of claim 2 wherein the cache node is located in the remote management system.

4. The method of claim 1 wherein the first communication node and the second communication node are members of a communication group controlled by the remote management system.

5. The method of claim 1 wherein the first communication node comprises a first discrete device paired with a first personal communication device; and further wherein the second communication node comprises a second discrete device paired with a second personal communication device.

6. The method of claim 1 wherein the remote management system comprises a computing system.

7. The method of claim 1 further comprising:
opening a second deposit channel from a third communication node to the storage system, wherein the third deposit channel is configured to permit transfer of the third node data from the third first communication node to the storage system;
wherein the first retrieval channel is configured to permit transfer of the third node data from the storage system to the second communication node.

8. A remote management system for managing group communications among communication nodes, the system comprising:
one or more processors;
a computer readable storage medium having instructions stored thereon that, when executed by the one or more processors, cause the management system to:
open a first deposit channel from a first communication node to a storage system in a cache network, wherein the first deposit channel is configured to permit transfer of first node data from the first communication node to the storage system; and
open a first retrieval channel from the storage system to a second communication node, wherein the first retrieval channel is configured to permit transfer of the first node data from the storage system to the second communication node.

9. The system of claim 8 wherein the storage system comprises a cache node configured to hold the first node data sent by the first communication node until the first node data is retrieved by the second communication node.

10. The system of claim 9 wherein the cache node is located in the remote management system.

11. The system of claim 8 wherein the first communication node and the second communication node are members of a communication group controlled by the remote management system.

12. The system of claim 8 wherein the first communication node comprises a first discrete device paired with a first personal communication device; and further wherein the second communication node comprises a second discrete device paired with a second personal communication device.

13. The system of claim 8 wherein the remote management system comprises a computing system.

14. The system of claim 8 wherein the instructions further cause the management system to:
open a second deposit channel from a third communication node to the storage system, wherein the third deposit channel is configured to permit transfer of the third node data from the third first communication node to the storage system;
wherein the first retrieval channel is configured to permit transfer of the third node data from the storage system to the second communication node.

15. A method of operating a cache network for a communication node group comprising a first communication node and a second communication node, the method comprising:
receiving first node data from the first communication node through a deposit channel;
storing the first node data in a storage system in the cache network;
retrieving the first node data from the storage system; and
transmitting the first node data to the second communication node using a retrieval channel.

16. The method of claim 15 wherein the deposit channel and the retrieval channel are opened based on instructions from a remote management system.

17. The method of claim 15 wherein the storage system comprises a cache node in which the first node data is stored.

18. The method of claim 17 wherein the cache node is part of a remote management system.

19. The method of claim 15 wherein the first communication node comprises a first discrete device paired with a first personal communication device; and further wherein the second communication node comprises a second discrete device paired with a second personal communication device.

20. The method of claim 19 wherein the deposit channel and the retrieval channel are opened based on instructions from a remote management system, wherein the remote management system controls group formation and changes for the communication node group.
